(19) United States
(12) Patent Application Publication
(10) Pub. No.: US 2007/0276725 A1
(43) Pub. Date: Nov. 29, 2007

(54) Athletic Redemption for Life Skill Development

(76) Inventor: Samuel B. Kellett, Atlanta, GA (US)

Correspondence Address: Kangaroo Bob's, LLC, c/o Biggers & Ohanlan, LLP, P.O. Box 1469, Austin, TX, 78767-1469, US

(21) Appl. No.: 11/420,082

(22) Filed: May 24, 2006

(51) Int. Cl. G07G 1/14

(52) U.S. Cl. 705/14

(57) ABSTRACT

Methods and soft contained play centers for athletic redemption for life skill development are provided. Embodiments include observing a child playing an athletic game in a soft contained play center wherein success in playing the athletic game is predetermined to be linked to exhibiting predefined aspects of the particular life skill; determining that the child exhibited one or more of the predefined aspects of the particular life skill while playing the game; providing a redeemable reward to the child for exhibiting the predefined aspect of the life skill; and redeeming the reward for a prize.

### BACKGROUND OF THE INVENTION

1. Field of the Invention

The field of the invention is methods and soft contained play centers for athletic redemption for life skill development.

2. Description of Related Art

Children enjoy playing on inflatable play areas often found in recreational centers for children. Such recreational centers often provide for a fee unstructured play for children. While the children may enjoy playing on the inflatable play centers, their caregivers see this activity only as play and not as education. There is therefore an ongoing need for improvement in the area of conventional recreation centers.

### SUMMARY OF THE INVENTION

Methods and soft contained play centers for athletic redemption for life skill development are provided. Embodiments include observing a child playing an athletic game in a soft contained play center wherein success in playing the athletic game is predetermined to be linked to exhibiting predefined aspects of the particular life skill; determining that the child exhibited one or more of the predefined aspects of the particular life skill while playing the game; providing a redeemable reward to the child for exhibiting the predefined aspect of the life skill; and redeeming the reward for a prize.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth block diagram illustrating the layout of an exemplary soft contained play center according to the present invention.

FIG. 2 sets forth a flow chart illustrating an exemplary method for athletic redemption for life skill development according to the present invention.

FIG. 3 sets forth a flow chart illustrating an exemplary method for observing a child playing an athletic game in a soft contained play center.

FIG. 4 sets forth a block diagram illustrating a specific example of an athletic game useful in teaching children a targeted life skill in a soft contained play center according to the present invention.

FIG. 5 sets forth a flow chart illustrating an exemplary method for providing a redeemable reward to the child for exhibiting the predefined aspect of the life skill.

### DETAILED DESCRIPTION OF EXEMPLARY EMBODIMENTS

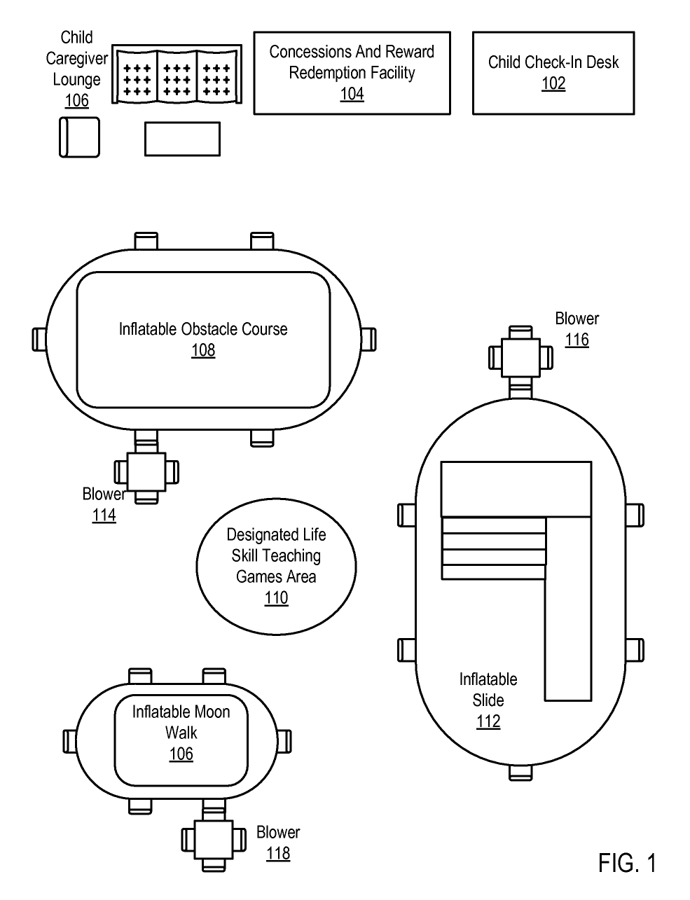

Exemplary methods and soft contained play centers for athletic redemption for life skill development according to embodiments of the present invention are described with reference to the accompanying drawings, beginning with FIG. 1. FIG. 1 sets forth a block diagram of a soft contained play center according to the present invention. A soft contained play center is a recreational area for children containing one or more inflatable play areas. Soft contained play centers according to the present invention include both indoor recreational areas having inflatable play areas and outdoor recreational areas having inflatable play areas. The exemplary soft contained play center of FIG. 1 is configured for athletic redemption for life skill development. Athletic redemption for life skill development according to the present invention advantageously rewards the development of a particular life skill though the use of redeemable rewards thereby facilitating the learning of the life skill.

The soft contained play center of FIG. 1 includes a plurality of inflatable play areas (106, 108. and 112). Inflatable play areas are inflated structures typically made of vinyl, typically inflated with air by one or more blowers, and often designed according to a theme. The inflatable play areas of FIG. 1 includes an inflatable obstacle course (108) inflated by blower (114), an inflatable slide (112) inflated by blower (116), and an inflatable moon walk (106) inflated by blower (118).

The inflatable obstacle course (108), inflatable slide (112), and inflatable moonwalk (106) of FIG. 1 are presented for explanation and not for limitation. In fact, soft contained play centers may include any number of different kinds inflatable play areas such as inflatable boxing rings, castles, sport cages, basket ball courts, gladiator coliseums, mountains, bouncers, jumpers, mazes, and many others as will occur to those of skill in the art.

The soft contained play center of FIG. 1 includes a designated games area (110). The designated games area (110) is a predetermined portion of the soft contained play center configured for playing an athletic game designed to teach a targeted life skill. A life skill is a trait of adults identified as beneficial to the success or well being of the adult. Examples of such life skills include teamwork, manners, self confidence, honesty, trustworthiness, and many others as will occur to those of skill in the art. The teaching of many such targeted life skills may be facilitated by use of athletic redemption according to the present invention.

A life skill has one or more related aspects. Aspects of a life skill are specific characteristics of that life skill. For example, some aspects of the life skill of teamwork include hard work, closeness, leadership, reliability, working together, enthusiasm, emotional control, awareness, no fear of failure, determination, talent, training, team spirit, preparedness, principled, being the best that one can, as well as others as will occur to those of skill in the art.

The soft contained play center of FIG. 1 is also configured for athletic redemption for life skill development. The soft contained play center of FIG. 1 is configured for observing a child playing an athletic game wherein success in playing the athletic game is predetermined to be linked to exhibiting predefined aspects of the particular life skill; determining that the child exhibited one or more of the predefined aspects of the particular life skill while playing the game; providing a redeemable reward to the child for exhibiting the predefined aspect of the life skill; and redeeming the reward for a prize.

The soft contained play center of FIG. 1 is also configured for advising, prior to playing the game, the child of the predefined aspects of the particular life skill to be rewarded. An instructor of the soft contained play center may advise one or more children playing the athletic game of the particular life skill taught by the athletic game that will be rewarded with a redeemable reward. Advising children of the predefined aspects taught by the athletic game focuses the attention of the children on the predefined aspects of the life skill.

Instructors in the soft contained play center may also verbally acknowledge to the child the predefined aspects of the particular life skill exhibited when providing the redeemable reward. Verbally acknowledging to the child the predefined aspects of the particular life skill exhibited when providing the redeemable reward positively reinforces the reward to facilitate learning of the life skill.

Instructors in the soft contained play center may also verbally acknowledge to the child's caretaker the predefined aspects of the particular life skill exhibited when providing the redeemable reward. Verbally acknowledging to the child's caretaker the predefined aspects of the particular life skill exhibited when providing the redeemable reward demonstrates to the child's caregiver the benefits for the child in participating in activities provided by the soft contained play center.

The soft contained play center of FIG. 1 also includes a concessions and reward redemption facility (104). Concessions and reward redemption facility (104) includes concessions for sale and a selection of prizes available for exchange for one or more of the redeemable rewards given to the children having exhibited aspects of the one or more life skill taught in the soft contained play center. Prizes may be redeemed from redeemable rewards, such as tickets for example, received by a child from an instructor for exhibiting predefined aspects of one or more life skills while playing selected athletic games in the soft contained play center.

The soft contained play center of FIG. 1 also includes a child caregiver lounge (106). A child caregiver lounge (106) is an area designed for caregivers of children to wait, work, or relax while instructors of the soft contained play center administer structured and unstructured play of the children including teaching children a targeted life skill and rewarding the children through athletic redemption for life skill development according to the present invention.

The soft contained play center of FIG. 1 also includes a child check-in desk (102). The child check-in desk (102) is typically located near the entrance of the soft contained play center and is used to accept entrance of the child in the soft contained play center. In some soft contained play centers according to the present invention, each child is tagged with an Radio Frequency Identification (‘RFID’) tag that sets off an alarm if the child leaves the soft contained play center while wearing the RFID tag.

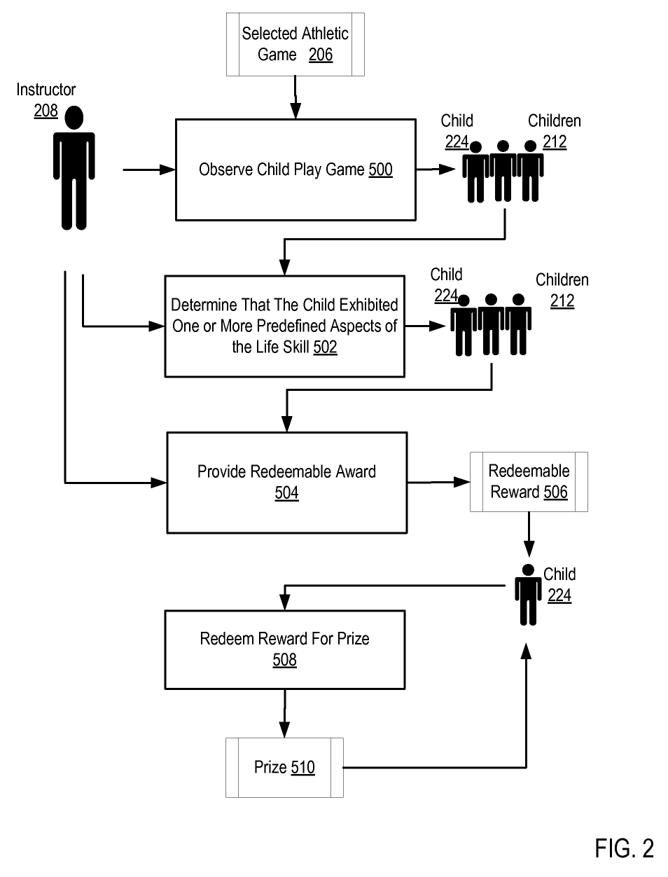

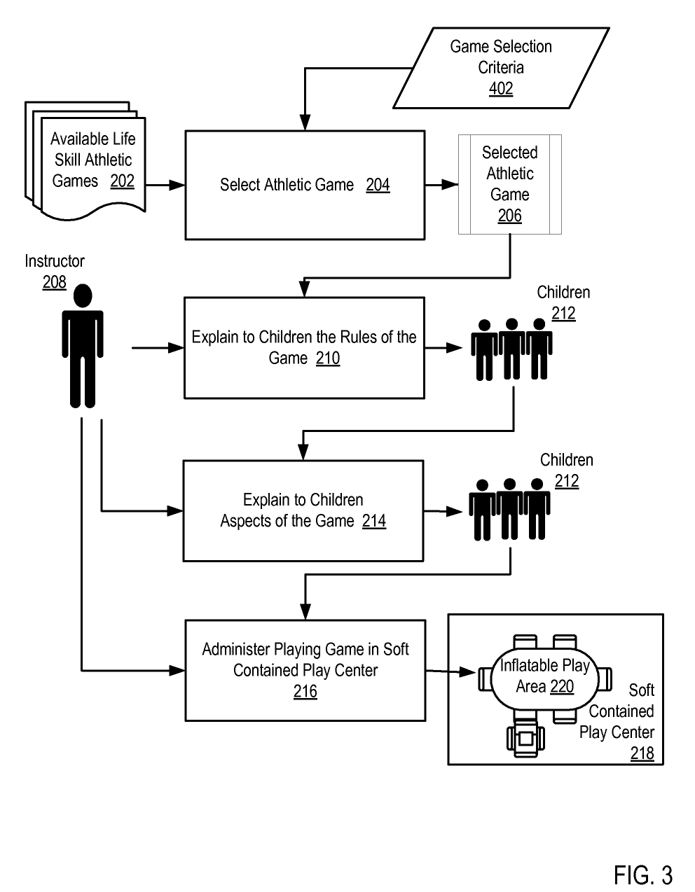

Soft contained play centers according to the present invention are configured for athletic redemption for life skill development according to the present invention. For further explanation, FIG. 2 sets forth a flow chart illustrating an exemplary method for athletic redemption for life skill development according to the present invention. The method of FIG. 2 includes observing (500) a child (224) playing an athletic game (206) in a soft contained play center, wherein success in playing the athletic game is predetermined to be linked to exhibiting predefined aspects of the particular life skill. Observing (500) a child (224) playing an athletic game (206) in a soft contained play center according to the method of FIG. 2 may be carried out by selecting an athletic game (206), explaining to one or more children (212) the rules of the selected athletic game (206); explaining (214) to the children (212) the one or more predefined aspects of the targeted life skill linked to success in playing the selected athletic game (206); and administering (216) the playing of the selected athletic game (206) by the children (212) in a soft contained play center (218) as discussed below with reference to FIG. 3.

Often the athletic game according to the present invention comprises a themed game having one or more components of the theme. Such components of the theme are often based upon the one or more predefined aspects of the targeted life skill linked to success in playing the game. Themed games may usefully increase a child's interest in the game, and therefore, may facilitate development of the life skill taught through playing the game.

Often athletic redemption for life skill development in a soft contained play center according to the method of FIG. 2 also includes advising, prior to playing the game, the child of the predefined aspects of the particular life skill to be rewarded. Advising the child of the predefined aspects of the particular life skill to be rewarded may focus the attention of the child on those predefined aspects of the particular life skill thereby facilitating development of life skill taught through playing the game.

Often athletic redemption for life skill development in a soft contained play center according to the method of FIG. 2 may also include initiating the athletic game after a period of free play for children in the soft contained play center. Free play is unstructured play in the soft contained play center. Free play provides additional enjoyment for the children in the soft contained play center thereby increasing the overall enjoyment of the child in the soft contained play center.

The method of FIG. 2 also includes determining (502) that the child (224) exhibited one or more of the predefined aspects of the particular life skill while playing the game. Determining (502) that the child (224) exhibited one or more of the predefined aspects of the particular life skill while playing the game typically may be carried out by identifying, by an instructor, the predefined aspects of the particular life skill that are predetermined to be linked to success in playing the athletic game. Predefined aspects of the particular life skill are exhibited by performing one or more defined physical activities in the selected athletic game that demonstrate the aspects of the life skill. For example, in a ball game for teaching teamwork, the physical activity of passing a ball may demonstrate the predefined aspect of working together, which is a predefined aspect of teamwork.

The method of FIG. 2 also includes providing (504) a redeemable reward (506) to the child (224) for exhibiting the predefined aspect of the life skill. A redeemable reward is an award that may redeemed for a prize. Such redeemable rewards may also be coupled with other redeemable rewards for prizes of increasing value often provided by soft contained play centers according to the present invention. One example of a redeemable reward capable of being coupled with other redeemable rewards for prizes of increasing values is a paper ticket. That is, prizes of higher value may be available for more paper tickets than prizes of lower value. The use of redeemable rewards provides a vehicle for rewarding the child with a prize that the child finds most satisfying thereby increasing the reinforcement the life skill development.

The method of FIG. 2 also includes redeeming (508) the reward (506) for a prize (510). Redeeming (508) the reward (506) for a prize (510) according to the method of FIG. 2 is typically carried out by exchanging the redeemable reward for one or more prizes. Soft contained play centers may provide, for example, a reward redemption facility providing one or more prizes, often of increasing value, for redemption by exchanging the prizes for one or more redeemable rewards provide to children for exhibiting predefined aspects of life skills according to the present invention.

As discussed above, athletic redemption for life skill development in a soft contained play center according to the present invention includes observing a child playing an athletic game in a soft contained play center. For further explanation, therefore, FIG. 3 sets forth a flow chart illustrating an exemplary method for observing a child playing an athletic game in a soft contained play center. The method of FIG. 3 includes selecting (204) an athletic game (206). The selected athletic game of FIG. 3 is designed to be played in designated areas in the soft contained play center or on one or more inflatable play areas in the soft contained play center. The selected athletic game of FIG. 3 is also designed with specific physical activities demonstrating one or more individual aspects of the life skill taught through the game. The rules of the selected athletic game are typically designed such that success in playing the selected athletic game (206) is predetermined to be linked to exhibiting one or more predefined aspects of the particular life skill by exhibiting the physical activities demonstrating those predefined aspects.

Often athletic games selected according to the method of FIG. 3 are themed athletic games targeted at a particular life skill and targeted for children of a particular ages and skill levels. In the example of FIG. 3, selecting (204) an athletic game (206) according to the method of FIG. 3 is carried out in dependence upon game selection criteria (402). Game selection criteria (402) are factors for determining which athletic game to select for teaching the targeted life skill and when to select the athletic game. Examples of game selection criteria include the number of children to play the game, the ages of the children to play the game, a game history including which games have been played and when the games are played, the competence of the instructors available to administer the game, the type of game played during a game selection time period and others as will occur to those of skill in the art.

Soft contained play centers according to the present invention may provide a curriculum of aspects of the predefined life skill. Such a curriculum may be taught by playing a plurality of games that together cover the aspects of the life skill comprising the life skill. Selecting an athletic game according to the method of FIG. 3 may therefore also include selecting a game from a plurality of games in dependence upon the aspects of the life skill taught by the game and a life skill curriculum.

To keep children interested in playing the athletic games and therefore in learning the targeted life skill, selecting an athletic game according to the method of FIG. 3 may include periodically selecting an athletic game at predetermined incremental time periods. The incremental time period, such as for example, every 15 minutes, is typically designed to facilitate the interest of the child in the game and also provide repetition for learning the life skill.

The method of FIG. 3 includes explaining (210) to one or more children (212) the rules of the selected athletic game (206). Explaining the rules of the game to one or more children according to the method of FIG. 3 may include telling a predetermined story designed to explain the rules of the game. Telling a predetermined story designed to explain the rules of the game advantageously holds the attention of children thereby increasing the ability of the children to learn the rules of the game.

The method of FIG. 3 includes explaining (214) to the children (212) the one or more predefined aspects of the targeted life skill linked to success in playing the selected athletic game (206). Explaining to the children the one or more predefined aspects of the targeted life skill linked to success in playing the game may also include telling a predetermined story designed to explain the one or more aspects of the targeted life skill to be rewarded. Telling a predetermined story designed to explain the one or more predefined aspects of the targeted life skill linked to success in playing the game advantageously holds the attention of children thereby increasing the ability of the children to learn the predefined aspects of the targeted life skill linked to success in playing the game.

The method of FIG. 3 includes administering (216) the playing of the selected athletic game (206) by the children (212) in a soft contained play center (218). Administering the playing of the selected athletic game in a soft contained play center may be carried out by supervising, by an instructor of the (208) of the soft contained play center, the playing of the game in a designated game area in a soft contained play center or supervising the playing of the game on inflatable play areas in a soft contained play center.

Some athletic games useful in teaching children a targeted life skill in a soft contained play center according to the present invention may be team games having more than one team. In such cases, administering (216) the playing of the selected athletic game (206) by the children in a soft contained play center (218) typically includes assigning the children to one or more teams. Assigning the children to one or more teams may be carried out by assigning children to one or more teams in dependence upon a number of factors such as the age of the children, the type of selected game, the physical attributes of the individual children, the accomplishments with regard to a curriculum of the individual children, and many more as will occur to those of skill in the art.

Children often learn through repetition. Administering (216) the playing of the selected athletic game (206) by the children in a soft contained play center (218), therefore, may also include playing the game for a predetermined number of times. Playing a set of the game, that is, playing the game for a predetermined number of times advantageously reinforces the aspects of the life skill taught through the playing of the game.

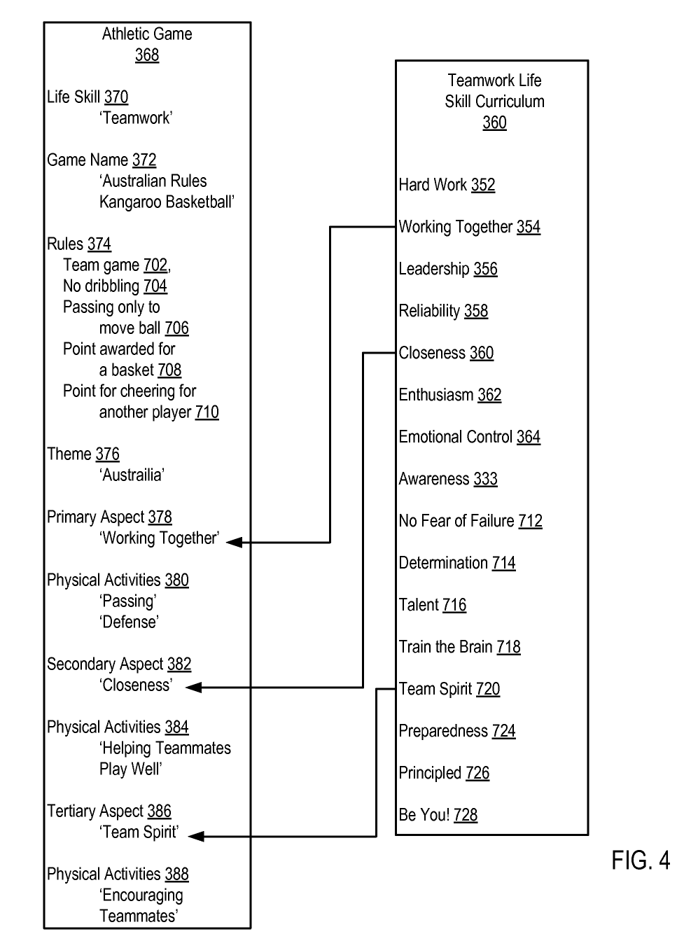

As discussed above, often athletic games useful in athletic redemption for life skill development in a soft contained play center according to the present invention are themed athletic games targeted at a particular life skill. For further explanation, therefore, FIG. 4 sets forth a block diagram illustrating a specific example of an athletic game designed for teaching children a targeted life skill in a soft contained play center according to the present invention. In the example of FIG. 4, the athletic game (368) is designed for teaching the life skill (370) ‘Teamwork’ and has a game name (372) of ‘Australian Rules Kangaroo Basketball.’

The exemplary athletic game (368) of FIG. 4 includes rules (374) designed such that success in playing Australian Rules Kangaroo Basketball is predetermined to be linked to exhibiting three aspects of teamwork. The three aspects of teamwork linked to success in the game and are ‘Working Together,’ ‘Closeness,’ and ‘Team Spirit.’ The rules (374) of the exemplary athletic game (368) of Australian Rules Kangaroo Basketball define the game as a team game (702) wherein no dribbling of the basketball is allowed (704) and players may only advance or move the ball by passing (706) to one another. The rules (374) of the exemplary athletic game (368) of Australian Rules Kangaroo Basketball also reward a point to a player that shoots the ball in a basket (708) and a point for cheering for another player (710).

The exemplary athletic game (368) of Australian Rules Kangaroo Basketball includes a theme (376) of ‘Australia.’ Themed games advantageously provide additional enjoyment to the children, help the children remember the rules of the game, and help to make apparent to the children the aspects of the targeted life skill enhanced through the game.

As mentioned above, the exemplary athletic game (368) Australian Rules Kangaroo Basketball includes rules (374) designed such that success in playing the game is predetermined to be linked to exhibiting three aspects of teamwork. The three aspects of teamwork supported by the rules include a primary aspect (378) ‘Working Together.’ Demonstrating a primary aspect (378) of the targeted life skill (370) is predetermined to provide more success in playing the athletic game than other a secondary aspects or tertiary aspects. The aspect (378) of ‘Working Together’ has associated physical activities (380) that exhibit the aspect. The physical activities (380) of ‘Passing’ and playing ‘Defense’ are exhibit the aspect of ‘Working Together.’

The three aspects of teamwork supported by the rules of Australian Rules Kangaroo Basketball include a secondary aspect (382)‘Closeness.’ Demonstrating the secondary aspect (382) of the targeted life skill (370) is typically predetermined to provide success in playing the athletic game but less success than the primary aspect. The secondary aspect (382) of ‘Closeness’ has associated physical activities (384) that exhibit the secondary aspect. The physical activities (384) of ‘Helping Teammates Play Well’ exhibit the secondary aspect of ‘Closeness.’

The three aspects of teamwork supported by the rules of Australian Rules Kangaroo Basketball also include a tertiary aspect (386) ‘Team Spirit.’ Demonstrating the tertiary aspect (386) of the targeted life skill (370) is typically predetermined to provide success in playing the athletic game but less success than the primary aspect and the secondary aspect. The tertiary aspect (386) of ‘Team Spirit’ has associated physical activities (388) that exhibit the tertiary aspect. The physical activities (388) of ‘Cheering for Teammates’ is defined to exhibit the tertiary aspect of ‘Team Spirit.’

The three aspects of teamwork of Australian Rules Kangaroo Basketball are three aspects of team work that are included in a plurality of aspects of teamwork that define a teamwork life skill curriculum (360). A curriculum of aspects is a defined plurality of aspects of a particular life skill. Such a curriculum is useful is selecting games such that the games together exhibit all the aspects of the curriculum.

Following a curriculum also provides a structured way of teaching children many aspects of a particular targeted life skill and therefore teaching the children the life skill itself. The exemplary teamwork life skill curriculum (360) of FIG. 4 includes hard work (352), working together (354), leadership (356), reliability (358), closeness (360), enthusiasm (362), emotional control (364), awareness (333), no fear of failure (712), determination (714), talent (716), train the brain (718), team spirit (720), preparedness (724), and be you (728).

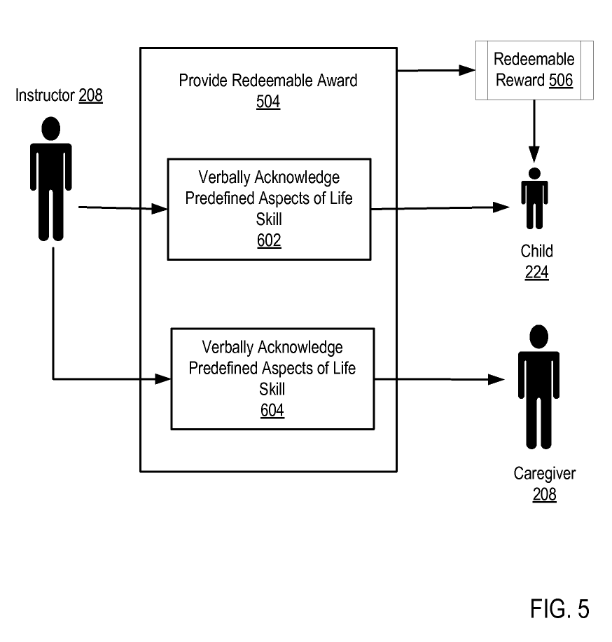

As discussed above, methods for athletic redemption for life skill development in a soft contained play center according to the present invention include providing a redeemable reward to the child for exhibiting the predefined aspect of the life skill. For further explanation, therefore, FIG. 5 sets forth a flow chart illustrating an exemplary method for providing a redeemable reward to the child for exhibiting the predefined aspect of the life skill. Providing (504) a redeemable reward (506) to the child (224) for exhibiting the predefined aspect of the life skill according to the method of FIG. 5 includes verbally acknowledging (602) to the child (224) the predefined aspects of the particular life skill exhibited when providing the redeemable reward (506). Verbally acknowledging (602) to the child (224) the predefined aspects of the particular life skill focuses the attention of the children on the predefined aspects of the life skill. Verbally acknowledging to the child the predefined aspects of the particular life skill exhibited when providing the redeemable reward also advantageously positively reinforces the reward to facilitate learning of the life skill.

Providing (504) a redeemable reward (506) to the child (224) for exhibiting the predefined aspect of the life skill according to the method of FIG. 5 also includes verbally acknowledging (604) to the child's caretaker (208) the predefined aspects of the particular life skill exhibited when providing the redeemable reward (506). Verbally acknowledging to the child the predefined aspects of the particular life skill exhibited when providing the redeemable reward advantageously positively reinforces the reward to facilitate learning of the life skill.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for athletic redemption for life skill development in a soft contained play center, the method comprising
observing a child playing an athletic game in a soft contained play center wherein success in playing the athletic game is predetermined to be linked to exhibiting predefined aspects of the particular life skill;
determining that the child exhibited one or more of the predefined aspects of the particular life skill while playing the game;
providing a redeemable reward to the child for exhibiting the predefined aspect of the life skill; and
redeeming the reward for a prize.

2. The method of claim 1 wherein the targeted life skill comprises teamwork.

3. The method of claim 1 wherein the athletic game further comprises a themed game having one or more components of the theme, each component of the theme based upon the one or more predefined aspects of the targeted life skill linked to success in playing the game.

4. The method of claim 1 further comprising advising, prior to playing the game, the child of the predefined aspects of the particular life skill to be rewarded.

5. The method of claim 1 wherein observing a child playing an athletic game in a soft contained play center further comprises:
selecting an athletic game, wherein success in playing the selected athletic game is predetermined to be linked to exhibiting one or more predefined aspects of the particular life skill; wherein the selected athletic game is designed to be played in a soft contained play center including inflatable play areas;
explaining to one or more children the rules of the selected athletic game;
explaining to the children the one or more predefined aspects of the targeted life skill linked to success in playing the selected athletic game; and
administering the playing of the selected athletic game by the children in a soft contained play center.

6. The method of claim 5 wherein selecting a game further comprises selecting a game from a plurality of games, wherein success in playing each of the athletic games is predetermined to be linked to exhibiting one or more predefined aspects of the particular life skill and the one or more predefined aspects of all the athletic games together comprise a life skill curriculum.

7. The method of claim 5 wherein selecting an athletic game further comprises periodically selecting an athletic game at incremental time periods.

8. The method of claim 1 wherein providing a redeemable reward to the child for exhibiting the predefined aspect of the life skill further comprises verbally acknowledging to the child the predefined aspects of the particular life skill exhibited when providing the redeemable reward.

9. The method of claim 1 wherein providing a redeemable reward to the child for exhibiting the predefined aspect of the life skill further comprises verbally acknowledging to the child's caretaker the predefined aspects of the particular life skill exhibited when providing the redeemable reward.

10. The method of claim 1 wherein providing a redeemable reward to the child for exhibiting the predefined aspect of the life skill further comprises providing a redeemable reward capable of being coupled with other redeemable rewards to redeem a prize.

11. The method of claim 1 wherein redeeming the reward for a prize further comprises providing a selection of prizes and exchanging one or more of the prizes for one or more of the redeemable rewards.

12. The method of claim 1 wherein the athletic game is designed to be played on inflatables in a soft contained play center.

13. A soft contained play center, the soft contained play center comprising:
one or more inflatable play areas; and
a reward redemption facility;
the soft contained play center configured for athletic redemption for life skill development including:
observing a child playing an athletic game in a soft contained play center wherein success in playing the athletic game is predetermined to be linked to exhibiting predefined aspects of the particular life skill;
determining that the child exhibited one or more of the predefined aspects of the particular life skill while playing the game;
providing a redeemable reward to the child for exhibiting the predefined aspect of the life skill; and
redeeming the reward for a prize.

14. The soft contained play center of claim 13 wherein the targeted life skill comprises teamwork.

15. The soft contained play center of claim 13 wherein the athletic game further comprises a themed game having one or more components of the theme, each component of the theme based upon the one or more predefined aspects of the targeted life skill linked to success in playing the game.

16. The soft contained play center of claim 13, wherein rewarding the development of a particular life skill further comprises advising, prior to playing the game, the child of the predefined aspects of the particular life skill to be rewarded.

17. The soft contained play center of claim 13 wherein providing a redeemable reward to the child for exhibiting the predefined aspect of the life skill further comprises verbally acknowledging to the child the predefined aspects of the particular life skill exhibited when providing the redeemable reward.

18. The soft contained play center of claim 13 wherein providing a redeemable reward to the child for exhibiting the predefined aspect of the life skill further comprises verbally acknowledging to the child's caretaker the predefined aspects of the particular life skill exhibited when providing the redeemable reward.

19. The soft contained play center of claim 13 wherein the reward redemption facility further comprises a selection of prizes for exchange for one or more of the redeemable rewards.

20. The soft contained play center of claim 13 wherein the athletic game is designed to be played on inflatables in a soft contained play center.
